(19) United States
(12) Patent Application Publication
(10) Pub. No.: US 2002/0083122 A1
(43) Pub. Date: Jun. 27, 2002

(54) Method and apparatus for the use of a network system for biofeedback stress reduction

(76) Inventor: Marc S. Lemchen, New York, NY (US)

Correspondence Address: MYERS, DAWES & ANDRAS LLP, Suite 650, 650 Town Center Drive, Costa Mesa, CA, 92626, US

(21) Appl. No.: 09/746,947

(22) Filed: Dec. 21, 2000

(51) Int. Cl. G06F 15/16

(52) U.S. Cl. 709/203; 709/233

(57) ABSTRACT

A system for reducing stress comprises a computer which operates a software program. The program may be run locally or from a remote server via the world wide web. A user inputs information into the computer relating to his or her body, lifestyle, work schedule. A sensor may be attached to the user and coupled to the computer to receive autonomic signals from the user. The computer executes a series of stress reducing exercises which the user is directed to perform. The system monitors and records the user's compliance, or lack thereof. The system then adjusts the stress reducing exercises based the user's performance.

### BACKGROUND OF THE INVENTION

1. Field of the Invention

The invention relates generally to biofeedback systems and the use of computer networks, such as the Internet.

2. Description of Related Art

Stress is perhaps the most commonly voiced complaint in the world today. The media is rampant with stories of stress-induced illnesses, stress in the workplace, stress at home. The effect of stress on productivity, absenteeism, and interpersonal relationships is well documented in the literature. Published surveys report 43% of adults suffer adverse health effects due to stress; 75-90% of all visits to primary care physicians are for stress related complaints or disorders. Nearly half of all American workers suffer from symptoms of burnout, a reaction to stress on the job.

Stress, along with depression, if often unreported and untreated due to social stigma and failure to follow up with treatment. While many companies spend a considerable amount of time and money, as do individuals on their own, encouraging exercise programs and providing gym facilities, this does not directly address or stress nor allow an objective measurement of stress reduction. Both the perceived and actual benefits of stress reduction are well worth an investment of time, effort and money for the individual and especially for their employer.

Consequently, the reduction of stress may lead to improved health, greater productivity at work, less absenteeism and more productive behavior. Businesses would profit from greater efficiency from their employees while insurance companies benefit from reduced visits to physicians.

Therefore, an effective method of lowering stress using a biofeedback system which may be widely and efficiently used by office workers is needed.

### BRIEF SUMMARY OF THE INVENTION

The invention envisions a computer based stress reduction program with the ability to monitor compliance and progress either within the program itself or over the Internet. The program is interactive, using accepted techniques to measure body signs indicative of stress reduction and relaxation.

Once the program is downloaded into the client's computer, the user is asked routine health questions to rule out as best as possible any contraindications to the program or other factors which should be discussed with a physician. Upon completion of these forms, the client sets up a series of appointments with the “online” trainer. If more than an acceptable number of these appointments were not kept, the “trainer” moves the client back in the program, or invokes a time penalty making it harder to achieve the treatment milestones.

At the specified times during the day the computer brings up a conventional stress reduction program and the client performs the repetitive functions indicated to train them to control their stress reactions. Treatment is formatted to motivate the client, perhaps a “seven day program to measurable stress reduction”.

Another feature is the ability to initiate stress reduction sessions on demand for specific occasions, such as providing a five-minute program before a big presentation or meeting with an employer or prospective customer. Stress reduction sessions could also be specially invoked following a difficult client or loss of an account.

This therapy is not intended to replace professional care. It is couched in the concept of autosuggestion, a way of putting ourselves into a certain mindset, which makes us better able to cope with a particular situation, or even to concentrate better for a specific period of time. Perceiving that we have a way of focusing our energies on a particular task, or of eliminating the interference of other factors with our other tasks would allow one to be more productive.

One of the primary sites of use is in corporate networks to encourage employees to pursue stress reduction. The corporation would not necessarily monitor their progress or compliance, but could do so within the limits of legal privacy concerns. The system could also be used directly to the individual. Its use could be tied to other motivational programs, with weight reduction or antismoking programs where various unwanted behaviors have their basis or genesis in underlying stress. A third field of use would be through health insurance companies. Insurers would either provide the program to their insureds at no cost, or even to insist on the insured member using the program and learning the basic methods of stress reduction in exchange for lower rates. All of these uses could be provided over a broad field using computer networks, such as intranets or the internet.

The invention is defined as a biofeedback system in a computer network for treating stress in a user of the computer network comprising a computer coupled to the computer network for executing a program to generate a schedule of stress reduction exercises personalized to the user and to be performed by the user. The computer receives biofeedback input from the user. At least one sensor senses body stress signals from the user to provide the biofeedback input to the computer. The body stress signals are communicated to the computer.

The program monitors compliance by the user with the schedule of stress reduction exercises. The schedule of stress reduction exercises is modified according to the compliance of the user with the schedule, according to the performance of the user in the stress reduction exercises, according to situational events to which the user is subjected, according to biofeedback from the user during performance of the stress reduction exercises or at times other than during the performance of the stress reduction exercises, according to information input into the computer by the user relating to personalized stress characteristics of the user, and/or according to information input into the computer by the user relating to personalized stress related history of the user.

The system further comprises a remote server hosting the program and the program is run directly from the remote server via the network. Alternatively the program is downloaded by the user from the remote server via the computer network, such as an intranet or the internet and is run on the computer.

The invention is also a method of reducing stress using a computer network comprising the steps of inputting personal stress factors relating to a user through a user's client computer coupled to the computer network; receiving body stress signals from the user through the user's client computer; and generating a schedule of stress reducing exercises personalized to the user and to be performed by the user based on the personal stress factors relating to the user.

The method further comprises the steps of: monitoring compliance by the user with the schedule of stress reduction exercises on the user's client computer; modifying the schedule of stress reduction exercises according to the compliance of the user with the schedule; modifying the schedule of stress reduction exercises according to the performance of the user in the stress reduction exercises; modifying the schedule of stress reduction exercises according to situational events to which the user is subjected; modifying the schedule of stress reduction exercises according to biofeedback from the user during performance of the stress reduction exercises; modifying the schedule of stress reduction exercises according to biofeedback from the user at times other than during the performance of the stress reduction exercises; modifying the schedule of stress reduction exercises according to information input into the computer by the user relating to personalized stress characteristics of the user; modifying the schedule of stress reduction exercises according to information input into the computer by the user relating to personalized stress related history of the user.

In one embodiment the schedule of stress reducing exercises personalized to the user is generated on a remote server coupled through the computer network to the user's client computer. In another embodiment the schedule of stress reducing exercises personalized to the user is generated on the user's client computer. The step of monitoring compliance by the user with the schedule of stress reduction exercises on the user's client computer is performed on a remote server via the computer network, or may be monitored on the user's client computer.

The invention, now having been briefly summarized, may be better visualized by turning to the following drawings wherein like elements are referenced by like numerals.

### BRIEF DESCRIPTION OF THE DRAWINGS

FIG. 1 is a block diagram of a biofeedback system to reduce stress according to the invention.

FIG. 2 is a flow diagram of a program which operates the biofeedback system of FIG. 1.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS

A system for reducing stress comprises a computer 20, a display or other interactive communication device, and a memory which in combination operate pursuant to a software program. The program may be run locally or from a remote server via the internet or other network to which the computer 20 is coupled, such as a company intranet. A user 15 inputs information into the computer 20 relating to his or her personal information such as health history, work cycles, body, lifestyle, work tasks and future work schedules. Personal information relating to the user 15 which may be possible sources of stress may also be automatically input to the computer 20 from the local network to which the computer 20 is coupled. For example, the number of hours worked or billed by the user 15, and other work performance parameters may be available in the network and used as inputs to the computer 20 in relationship to stress diagnosis and therapy. A sensor coupled to the computer 20 may be attached to or communicate with the user 15 to provide appropriate physiological or autonomic signals from the user 15 to the computer 20. The program through the computer 20 diagnoses the user's stress level and in response directs the user 15 to undertake an appropriate series of stress reducing exercises, if needed. The system monitors and records the user's compliance, or lack thereof with the prescribed stress treatment. The system then adjusts the stress reducing exercises based the user's performance, or provides a report to a responsible health care provider in the case where there is lack of compliance or lack of stress reduction.

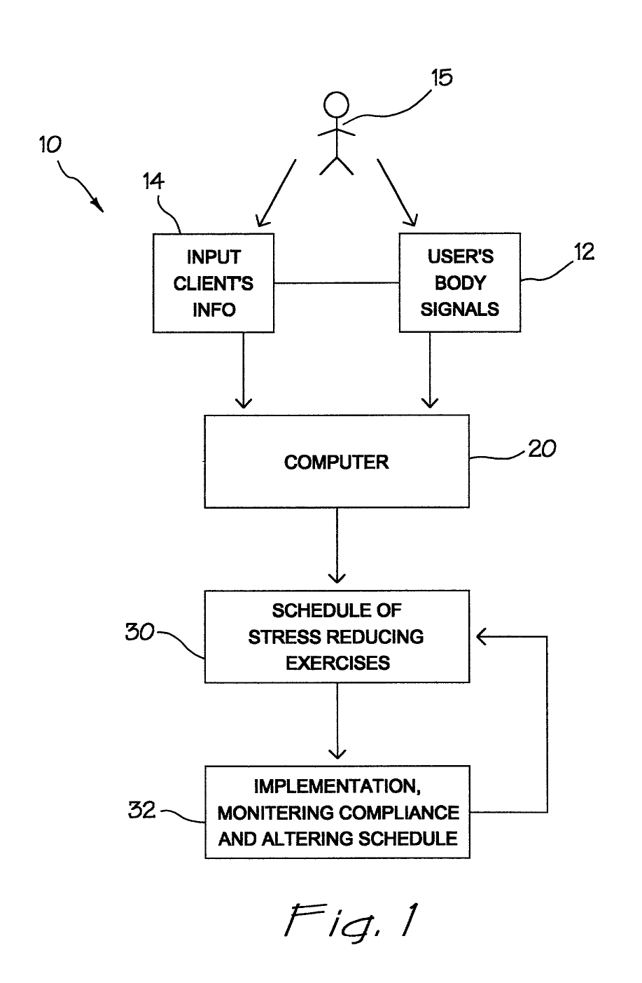

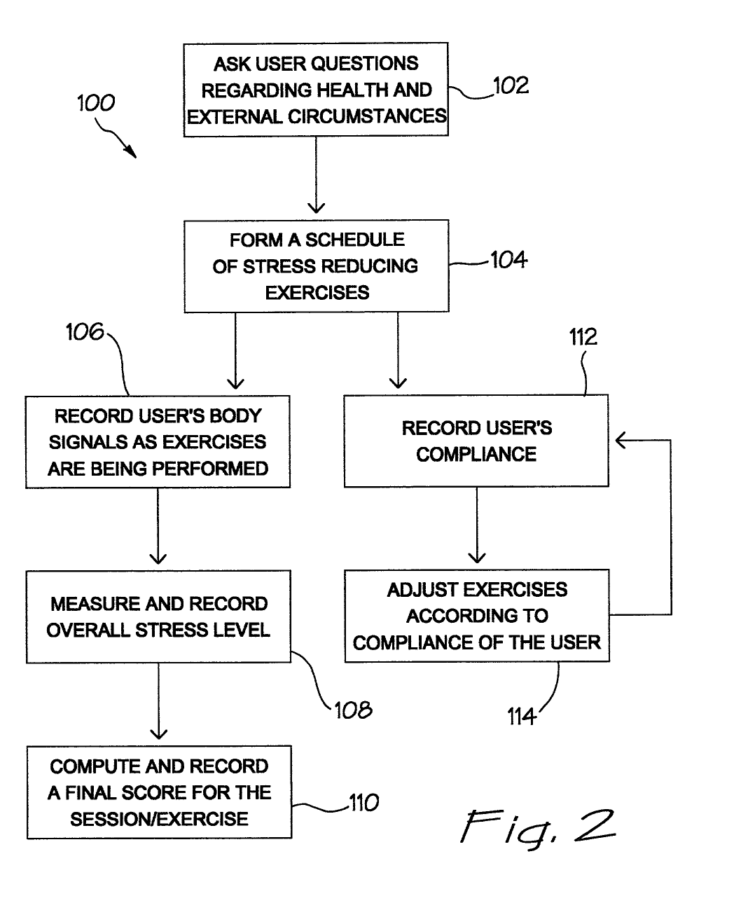

In FIG. 1, a biofeedback system 10 is provided to reduce stress. The system 10 comprises a computer 20 which receives input from a user 15. The computer 20 operates a software program 100, shown in FIG. 2, which may be stored locally in the computer 20 or remotely on a server. If the program 100 is stored remotely on a server, it may be accessed by the computer 20 via the internet, an intranet or another network to which computer 20 is coupled. Program 100 may then be downloaded into the computer 20 or executed from the remote server.

The user 15 is asked a series of questions to establish a personal profile regarding his or her health including lifestyle habits, diet, exercise routines, any known illnesses or physical conditions, and more as symbolically depicted in the flow diagram of FIG. 2 at step 102. Any information or history which might affect the user's propensity to be subject to stress can and would be included. The program 100 also asks user 15 questions regarding external circumstances, such as the user's type of occupation, work hours, upcoming events and deadlines, and more. Factors outside of work which might be contributory to stress would also be included subject to appropriate privacy restrictions.

In response to these questions, the user 15 inputs at step 102 of FIG. 2 information into the computer 20 through an input device 14, such as a keyboard, mouse, microphone, joystick, drawing pad or any other type of computer input device now known or later devised. Physiologic data can also be included at step 102, which is received from sensors 12 both at the time of interrogation and well as historical data. Sensor 12 can include any type of body sensor now known or later devised which is attached to or communicating with user 15. Currently such sensors include blood pressure monitors, heart monitors, temperature monitors, movement and perspiration sensors. Sensors 15 can typically be mounted in the mouse or keyboard with which user 15 is normally making contact during normal computer use. The program 100 analyzes this information, eliminates any contraindications, and alerts the user 15 to contact a referral physician chosen by user 15 if any information predictive of ill health is received.

Based on the user's input, a schedule 30 of stress reducing exercises 40 to be completed by the user 15 is created at step 104 of FIG. 2. The stress reducing instructions output by the computer 20 lead the user 15 into performing activities which reduce stress. For instance, the computer 20 may output instructions, either visually or audibly, telling the user 15 to begin breathing exercises, stretching exercises, relaxation, concentration, meditation and more. A sensor 12 is coupled to the user 15 and the computer 20 in order to monitor the user's autonomic condition as the user 15 engages in the exercises as shown in step 106 of FIG. 2. This information relating to the user's body may be stored in the computer 20 and analyzed in real-time to generate a measurement of the user's overall stress level as shown at step 108 of FIG. 2. Thus, throughout the performance of these exercises, the computer 20 not only records the autonomic signals received, but also the overall stress level measurements. The computer 20 also provides real-time audiovisual feedback to user 15 according to whether he is successfully performing the exercise or stress reducing task based on the signals received from the sensors 12 taking input from user 15.

From this data, various computations may be performed to analyze the user's improvement, or lack thereof at step 110 of FIG. 2. For instance, at the end of the each exercise session, the program 100 may cause the computer 20 to compute a final score based on the user's performance for the session. These scores may be recorded to allow the user 15 to monitor his or her progress.

Depending upon the type of information input into the computer 20 by the user 15, the computer 20 may run the exercises based on a set periodic time schedule, on the occurrence of specific external events such as prior or subsequent to a meeting, on the reception of certain autonomic signals from the user 15 via the sensor 12 such as when the user 15 is experiencing symptoms resulting from stress, on demand, or a combination of any of the above.

When it is time to run the exercise, the computer 20 will alert the user 15. Various methods may be employed to alert the user 15, including visual signals, sounds, and sending an e-mail to the user 15 if the program 100 is being performed from a remote server. The system 10 also monitors the user's compliance, or lack thereof is monitored at step 112 of FIG. 2. Monitoring compliance may be accomplished through the sensor 12 which can receive telling autonomic signals from the user 15 such as a decreased heart rate. Alternatively, the computer 20 may query the user 15 for input as the exercises are being run or after the exercises are completed. The user 15 would then have to respond to the queries by inputting information indicating that the exercises were completed by the user 15. Compliance may also be determined by querying user 15 in regard to various keys, which can only be known if the user has completed the exercise. For example, a certain exercise may use a specific symbol which is displayed when it is completed. User 15 will then be queried as to the nature of the displayed symbol for the exercise in question. Only a user who completed the exercise will know what the symbol was.

If the user 15 does not respond adequately to indicate that the exercises have been performed, the system 10 includes a memory module or database 32 to keep an accounting of the user's compliance. Should the user 15 fail to comply with an exercise, the system 10 will not only monitor and record the non-compliance, it will also adjust the exercise programs accordingly at step 114. For instance, if the user 15 fails to complete an exercise, the non-compliance is recorded and, consequently, an additional exercise regimen is added to the schedule. The system 10 may alternatively or in addition to adding the extra exercise, lengthen the duration of each exercise. In one sense, these automatic adjustments serve to discipline the user 15 in order to deter him or her from missing exercises in the future. In another sense, the adjustments serve to compensate for missing any exercises.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

What is claimed is:

1. A biofeedback system in a computer network for treating stress in a user of the computer network comprising:
a computer coupled to the computer network for executing a program to generate a schedule of stress reduction exercises personalized to the user and to be performed by the user, the computer receiving biofeedback input from the user; and
at least one sensor to sense body stress signals from the user to provide the biofeedback input to the computer, the body stress signals being communicated to the computer.

2. The system of claim 1 wherein the program monitors compliance by the user with the schedule of stress reduction exercises.

3. The system of claim 2 wherein the schedule of stress reduction exercises is modified according to the compliance of the user with the schedule.

4. The system of claim 1 wherein the schedule of stress reduction exercises is modified according to the performance of the user in the stress reduction exercises.

5. The system of claim 1 wherein the schedule of stress reduction exercises is modified according to situational events to which the user is subjected.

6. The system of claim 1 wherein the schedule of stress reduction exercises is modified according to biofeedback from the user during performance of the stress reduction exercises.

7. The system of claim 1 wherein the schedule of stress reduction exercises is modified according to biofeedback from the user at times other than during the performance of the stress reduction exercises.

8. The system of claim 1 wherein the schedule of stress reduction exercises is modified according to information input into the computer by the user relating to personalized stress characteristics of the user.

9. The system of claim 1 wherein the schedule of stress reduction exercises is modified according to information input into the computer by the user relating to personalized stress related history of the user.

10. The system of claim 1 further comprising a remote server hosting the program.

11. The system of claim 10 wherein the program is downloaded by the user from the remote server via the computer network and is run on the computer.

12. The system of claim 10 wherein the program is run directly from the remote server via the network.

13. A method of reducing stress using a computer network comprising:
inputting personal stress factors relating to a user through a user's client computer coupled to the computer network;
receiving body stress signals from the user through the user's client computer; and
generating a schedule of stress reducing exercises personalized to the user and to be performed by the user based on the personal stress factors relating to the user.

14. The method of claim 13 further comprising monitoring compliance by the user with the schedule of stress reduction exercises on the user's client computer.

15. The method of claim 14 further comprising modifying the schedule of stress reduction exercises according to the compliance of the user with the schedule.

16. The method of claim 13 further comprising modifying the schedule of stress reduction exercises according to the performance of the user in the stress reduction exercises.

17. The method of claim 13 further comprising modifying the schedule of stress reduction exercises according to situational events to which the user is subjected.

18. The method of claim 13 further comprising modifying the schedule of stress reduction exercises according to biofeedback from the user during performance of the stress reduction exercises.

19. The method of claim 13 further comprising modifying the schedule of stress reduction exercises according to biofeedback from the user at times other than during the performance of the stress reduction exercises.

20. The method of claim 13 further comprising modifying the schedule of stress reduction exercises according to information input into the computer by the user relating to personalized stress characteristics of the user.

21. The method of claim 13 further comprising modifying the schedule of stress reduction exercises according to information input into the computer by the user relating to personalized stress related history of the user.

22. The method of claim 13 wherein the schedule of stress reducing exercises personalized to the user is generated on a remote server coupled through the computer network to the user's client computer.

23. The method of claim 13 wherein the schedule of stress reducing exercises personalized to the user is generated on the user's client computer.

24. The method of claim 14 wherein monitoring compliance by the user with the schedule of stress reduction exercises on the user's client computer is performed on a remote server via the computer network.
